(19) United States
(12) Patent Application Publication
(10) Pub. No.: US 2025/0162436 A1
(43) Pub. Date: May 22, 2025

(54) DEVICE TO GRID DISCHARGING AND CHARGING

(71) Applicant: QUALCOMM Incorporated, San Diego, CA (US)

(72) Inventors: Mohit NARULA, San Diego, CA (US); Jonathan PETIT, Wenham, MA (US); Dan VASSILOVSKI, Del Mar, CA (US); Jean-Philippe MONTEUUIS, Northborough, MA (US); Mohammad Raashid ANSARI, Saugus, MA (US)

(21) Appl. No.: 18/516,611

(22) Filed: Nov. 21, 2023

(51) Int. Cl. B60L 53/30; B60L 53/63; B60L 53/66

(52) U.S. Cl. CPC B60L 53/305; B60L 53/63; B60L 53/66

(57) ABSTRACT

Aspects of the present disclosure relate to wireless communications, and more particularly, to techniques for device to grid charge transfer. Certain aspects are directed towards a method for device to grid charge transfer. The method generally includes: receiving, from a controller associated with an electric grid, a request for charge transfer from a wireless communication device to the electric grid, wherein the request indicates a power requirement for the electric grid during a time period; sending a message indicating whether the request for the charge transfer is accepted based on the power requirement; and initiating the charge transfer from the wireless communication device to the electric grid during the time period when the message indicates that the charge transfer is accepted.

### BACKGROUND

### Field of the Disclosure

Aspects of the present disclosure relate to wireless communications, and more particularly, to techniques for device to grid charge transfer.

### Description of Related Art

Electric grids face increasing challenges during periods of high electricity demand. Peaks in power consumption may be driven by various factor. Times of increased power consumption from the grid can strain the capacity of the grid infrastructure, leading to inefficiencies, reliability issues, and increased operating costs.

Vehicle-to-Grid (V2G) technology allows electricity to flow from vehicles to electric power lines. For example, V2G may be used to provide electric power to the grid during peak times, regulate the grid load, reduce storage requirements for the grid, and relieve the need for many fuel-based plants. During charging, the vehicle behaves as an electrical load, with the vehicle battery drawing power from the electric network of the grid. During discharging, the vehicle may act as a power source, injecting power into the grid. V2G may be used with fully electric, hybrid, or even hydrogen/solar or supplement fuel cell vehicles. A vehicle may include a communication controller (also referred to as an electrical vehicle communication controller (EVCC)) that may communicate with a communication controller of a charging station (e.g., also referred to as a service equipment communication controller (SECC)). The SECC may act as a bridge between the charging station's direct current (DC) charger and the vehicle battery management system. With hybrid and electric vehicle ownership increasing, an effective V2G system is important. Typical V2G systems fail to provide an efficient system for managing charge transfer. For example, current V2G systems fail to provide an organized and efficient system for coordinating and activating charge transfer to the grid.

### SUMMARY

Certain aspects are directed towards a method for device to grid charge transfer. The method generally includes: receiving, from a controller associated with an electric grid, a request for charge transfer from a wireless communication device to the electric grid, wherein the request indicates a power requirement for the electric grid during a time period; sending a message indicating whether the request for the charge transfer is accepted based on the power requirement; and configuring the charge transfer from the wireless communication device to the electric grid during the time period when the message indicates that the charge transfer is accepted.

Certain aspects are directed towards a method for device to grid charge transfer. The method generally includes: sending, from a controller associated with an electric grid, a request for charge transfer from a wireless communication device to the electric grid, wherein the request indicates a power requirement for the electric grid during a time period; receiving a message indicating whether the request for the charge transfer is accepted based on the power requirement; and configuring the charge transfer from the wireless communication device to the grid during the time period when the message indicates that the charge transfer is accepted.

Certain aspects are directed towards a method for device to grid charge transfer. The method generally includes: sending, from a controller associated with a wireless communication device, a request for charge transfer from the wireless communication device to an electric grid, wherein the request indicates an amount of power available for transfer to the electric grid during a time period; receiving a message indicating whether the request for the charge transfer is accepted; and configuring the charge transfer from the wireless communication device to the electric grid during the time period when the message indicates that the charge transfer is accepted.

Certain aspects are directed towards a method for device to grid charge transfer. The method generally includes: receiving, from a controller associated with a wireless communication device, a request for charge transfer from the wireless communication device to an electric grid, wherein the request indicates an amount of power available for transfer to the electric grid during a time period; sending a message indicating whether the request for the charge transfer is accepted; and configuring the charge transfer from the wireless communication device to the electric grid during the time period when the message indicates that the charge transfer is accepted.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a vehicle-to-grid (V2G) charge transfer system.

FIG. 6 illustrates V2G charge transfer system including an electric vehicle (EV) communication controller (EVCC), supply equipment (SE), and a secondary actor (SA).

FIG. 7 illustrates a V2G charge transfer system including multiple vehicles transferring charge to a grid.

FIG. 8 illustrates example signaling to perform grid-initiated V2G discharging, in accordance with certain aspects of the present disclosure.

FIG. 9 illustrates an example of signaling to perform vehicle-initiated V2G discharging, in accordance with certain aspects of the present disclosure.

FIG. 10 illustrates an example of signaling for V2G selective group transfer, in accordance with certain aspects of the present disclosure.

FIG. 11 illustrates a household with multiple vehicles participating in V2G charge transfer, in accordance with certain aspects of the present disclosure.

FIG. 12 illustrates example techniques for V2G transfer using communication between a grid controller and an SECC, in accordance with certain aspects of the present disclosure.

FIG. 13 shows an example of a method of device to grid charge transfer at a controller associated with a wireless communication device, in accordance with certain aspects of the present disclosure.

FIG. 14 shows an example of a method of device to grid charge transfer at a controller associated with a grid controller.

FIG. 15 shows an example of a method of device to grid charge transfer at a controller associated with a wireless communication device.

FIG. 16 shows an example of a method of device to grid charge transfer at a controller associated with a grid controller.

FIG. 17 depicts aspects of an example communications device.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects of the present disclosure provide apparatuses, methods, processing systems, and computer-readable mediums for device to electric grid charge transfer. While some aspects of the present disclosure are described with respect to charge transfer from a vehicle to an electric grid to facilitate understanding, certain aspects of the present disclosure may be applied for charge transfer from any device(s) (e.g., wireless communication device) to the electric grid.

Some aspects provide techniques for grid-initiated charge transfer to the electric grid. For example, a wireless communication device may receive, from a grid controller, a request for charge transfer from the device to the grid. The request may include various charge transfer parameters, such as a power requirement of the grid during a particular time period. Based on the request, the device may send a response either accepting or rejecting the request, as described in more detail herein.

Some aspects provide techniques for device-initiated (e.g., vehicle-initiated) charge transfer to the electric grid. For example, the device may send a request for charge transfer to the grid controller. The request may include charge transfer parameters such as the current battery percentage of the device, a charge transfer window, or total power available for transfer. The grid controller may either accept or reject the charge transfer. In some aspects, prior history of charge transfers may be used by the device to predict a period over which a charge transfer may be requested, providing an owner-agnostic and efficient manner of initiating charge transfer from the device to the grid.

Some aspects of the present disclosure are directed toward managing multiple wireless communication devices (e.g., vehicles) to collaborate for charge transfer to the grid. For example, a device may receive, from the grid controller, a request for a group charge transfer. The device may identify (e.g., via a request for vote and responses) one or more other devices to participate in the group charge transfer to the grid. Based on the participation of other devices, the device may either accept or reject the request from the grid controller for group charge transfer. In some cases, the device may also manage allocations of an amount of charge to be transferred by each device during the group charge transfer, as described in more detail herein.

Some aspects of the present disclosure are directed to techniques for charge transfer using communication between the grid controller and a supply equipment communication controller (SECC) associated with one or more wireless communication devices (e.g., instead of communication between the grid and the device itself). For example, the SECC may receive a request from the grid controller for charge transfer to the grid (or send a request for charge transfer to the grid). The SECC may then manage the setup and control of the charge transfer. For instance, the SECC may manage charge levels between the devices associated with the SECC so that any one device is not overly discharged.

Particular aspects of the subject matter described in this disclosure can be implemented to realize one or more of the following potential advantages. In some examples, the grid-initiated charge transfer provides techniques to manage and initiate charge transfer from one or more devices to the grid, increasing charge transfer efficiency. For example, the grid controller may indicate parameters, such as the power requirement of the grid, allowing the charge transfer to be performed at times when the grid has high power needs. Some aspects provide device-initiated charge transfer, allowing a device to request charge transfer to the grid in an efficient manner for the device. For example, the device may request a charge transfer when the device typically has excess charge. Device may consider charge transfer history to identify times when charge transfer is most suitable, providing an owner-agnostic and efficient manner of initiating charge transfer. Some aspects provide techniques for managing device groups (e.g., fleets of vehicles), allowing efficient management and coordination of a group of devices that can serve a grid's charge transfer requirements. In some aspects, charge transfer coordination may be performed with an SECC (e.g., instead of the device itself), keeping vehicle information private and allowing the SECC to coordinate the charge transfer efficiently.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

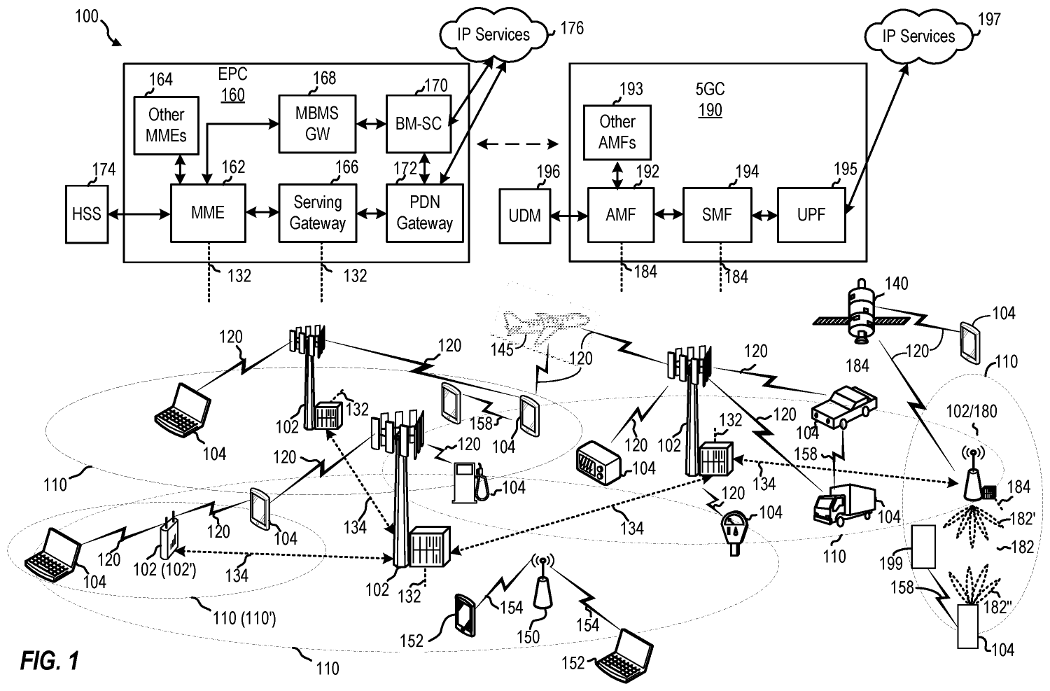

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

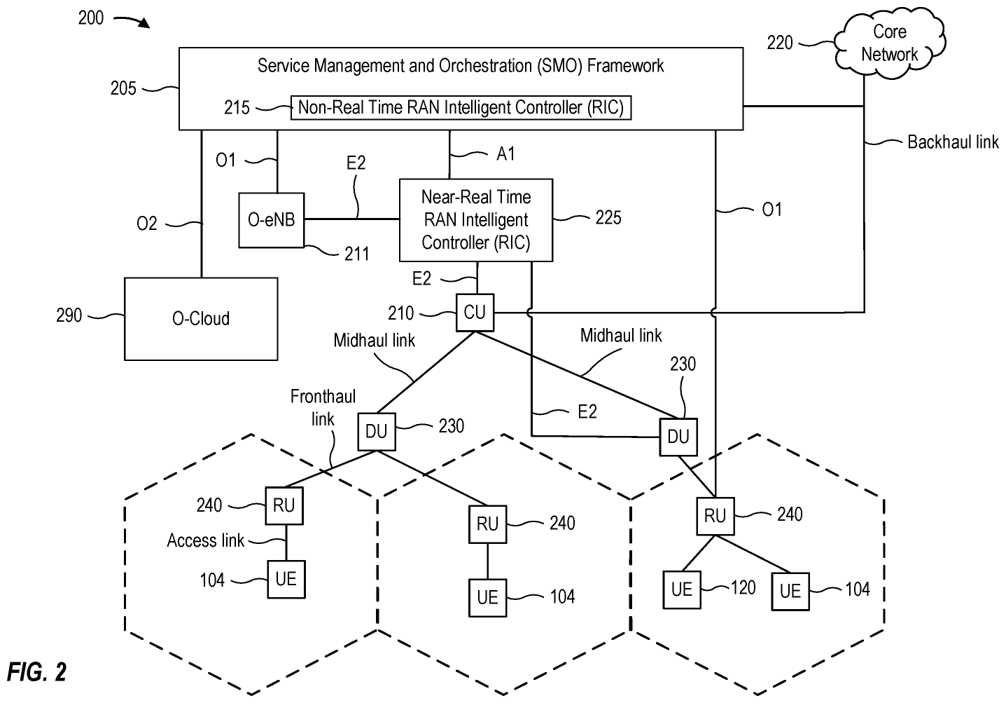

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158 (e.g., a PC5 link). D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

In some aspects, the UE described with respect to FIG. 1 may be any suitable controller or modem for a wireless communication device such as a vehicle. The UE may communicate with a controller 199 associated with an electric grid either through a Uu link or via sidelink (e.g., PC5 link).

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

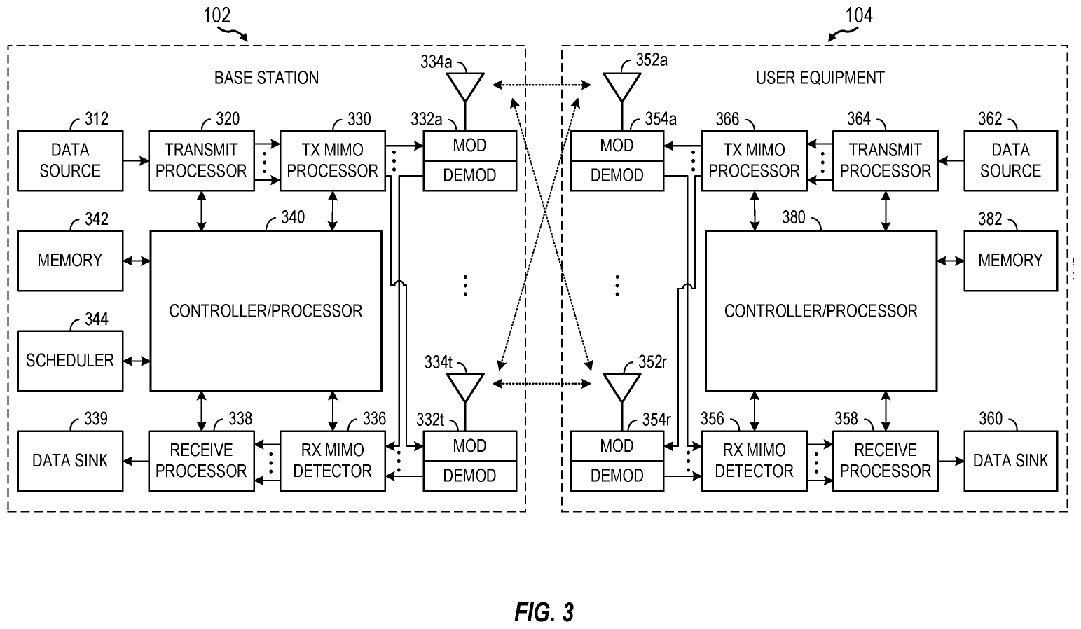

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

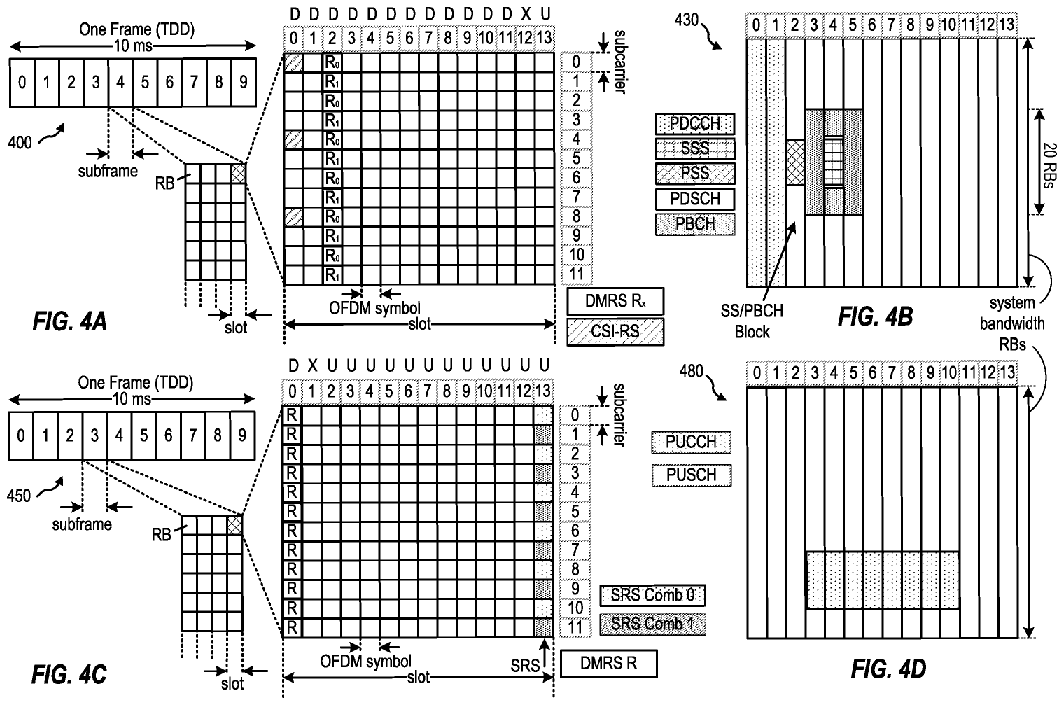

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Vehicle to Grid (V2G) Charge Transfer

Vehicle-to-Grid (V2G) is a technology that allows electricity to flow from cars (also referred to herein as “vehicles”) to electric power lines. V2G may be used to provide electric power to the grid during peak times, regulate and balance the grid load, reduce power storage, and reduce fossil fuel-based plants. During a charging operation, V2G charge transfer may behave like an electrical load since the battery is drawing power from the electric network. During a discharging operation, V2G power transfer behaves like a power source, injecting electricity into the grid. V2G may be used with fully electric, hybrid or even hydrogen, solar, or supplement fuel cell vehicles. While some aspects of the present disclosure are described with respect to charge transfer from a vehicle to an electric grid to facilitate understanding, certain aspects of the present disclosure may be applied for charge transfer from any wireless communication device(s) to the electric grid, such as a heating, ventilation, and air conditioning (HVAC) system.

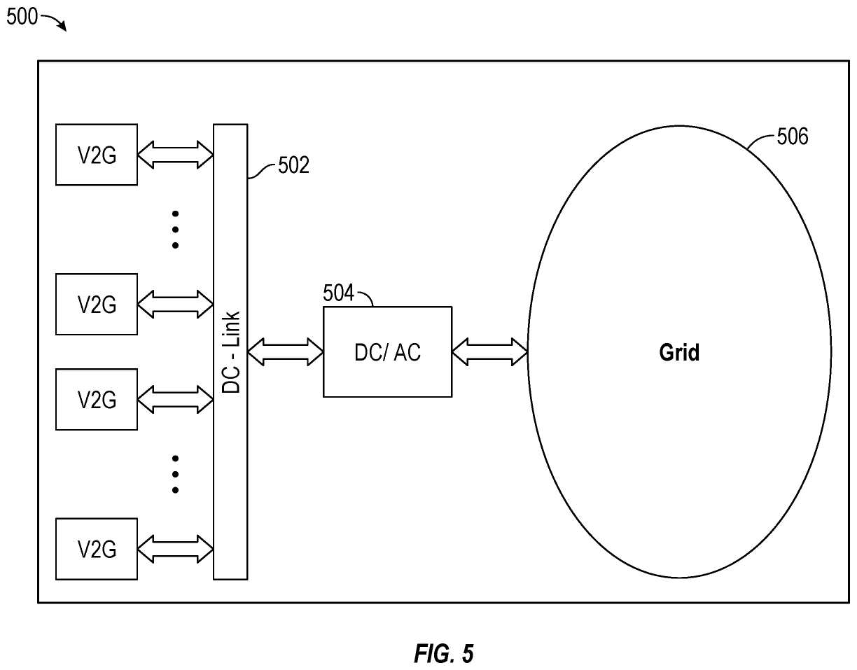

FIG. 5 illustrates a V2G charge transfer system 500. The system 500 may include multiple V2G devices (e.g., vehicles transferring charge to the grid), which may be coupled to a direct-current (DC) link 502. The DC power from the DC link 502 may be converted to alternating-current (AC) power via a DC-to-AC converter 504. The AC power may be provided to the grid 506, as shown. With increasing hybrid vehicle and electric vehicle (EV) ownership, an effective V2G discharging management service is important. A similar architecture may be implemented for any wireless communication device, allowing charge transfer from the device to the grid. For example, HVAC systems may be coupled to the DC link for charge transfer to or from the grid. In some aspects, the grid may be associated with a grid controller, and various parameters to facilitate charge transfer may be communicated between the devices and the grid controller. For instance, the device or the grid controller may request a charge transfer from the device to the grid, with parameters indicating the time for the transfer or the amount of charge to be transferred.

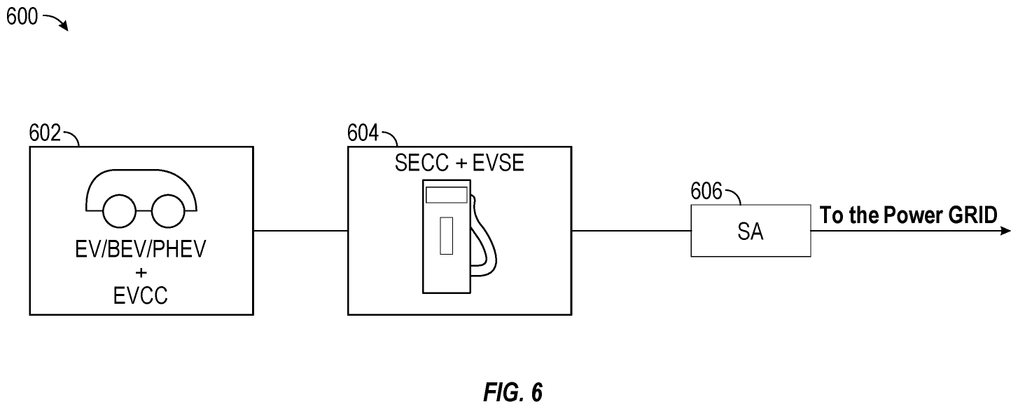

FIG. 6 illustrates an exemplary V2G charge transfer system 600 including EV communication controller (EVCC), supply equipment (SE), and a secondary actor (SA). As shown, a vehicle system 602 may include a vehicle, which may be an EV, battery EV (BEV), or plug-in hybrid EV (PHEV), communicably coupled to an EVCC. The EVCC may be coupled to a charger system 604, including SE communication controller (SECC) and EV supply equipment (EVSE). For example, the EVSE may include charging/discharging equipment, which may be private or public. The vehicle may be coupled to the charger using power-line communication (PLC), charging cable, or using inductive coupling. As shown, the charger system 604 may be coupled to a secondary actor 606 (e.g., via a transmission control protocol (TCP) connection or WiFi), which may be a software entity governed by public or private entities, such as a city gas and electric company or any public utility company. The secondary actor may also be a private entity, such as an owner of a parking structure (e.g., at which the charger system 604 may be located).

A cloud-connected grid and cellular-connected SECCs may communicate with each other to negotiate various attributes used to monitor energy specifications by the SECC and charge billing based on consumption. Certain aspects of the present disclosure are directed to techniques for the grid to inform vehicles about its need to supplement at peak loads. Certain aspects are directed towards a grid transmitting V2G discharge requests to vehicles that are served by the same grid, allowing such vehicles to transfer charge to serve the power needs of the grid. For example, it may not be useful to send a V2G discharge request to a vehicle that doesn't have a connection with the grid or may never connect to the grid for either V2G charging or discharging purposes.

In one scenario, a car owner may not be willing to authorize energy transfer from the vehicle to the grid due to an imminent trip. Certain aspects are directed towards how an owner of the EV may schedule a V2G discharge efficiently in terms of cost and energy. In another example, a single household may have several EVs. Certain aspects provide an efficient way of charging and/or discharging of multiple EVs by a cloud service.

Some aspects also provide techniques for managing V2G discharge in a fleet of vehicles. For example, it may not be efficient to discharge all vehicles in a company fleet at the same time. Certain aspects provide a distributed, time multiplexed, and coordinated V2G fleet management system, which may perform vehicle discharging based on availability, supply-chain demand, company's operations, and driver logistics. As another scenario, if every vehicle in a neighborhood activates vehicle charging during the same time window (e.g., during peak evening hours), the grid may not be able to supply a sudden surge in power. Conversely, suppose all vehicles activate V2G discharging within the same time window. In that case, a grid may not be ready, V2G discharge may go unmonitored, or the vehicles may trigger unnecessary signaling between EVCC and SECC or between SECC and SA. Therefore, a robust and secure method is important to organize, coordinate, and activate (or deactivate) discharging directly between EVCC and the grid or vice-versa.

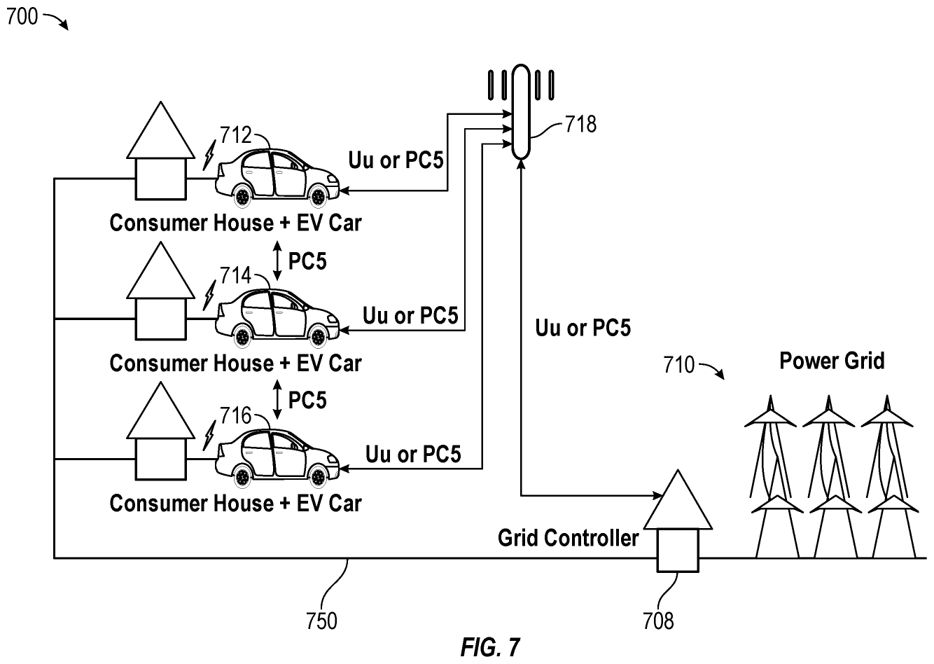

FIG. 7 illustrates a V2G charge transfer system 700 including multiple vehicles transferring charge to a grid. As shown, each of the vehicles 712, 714, 716 may be connected to a base station 718 (e.g., a 5G gNB or 5G cloud service, which may correspond to the BS 102 described with respect to FIG. 1). Each vehicle (e.g., corresponding to UE 104 described with respect to FIG. 1) may have a network connection through a Uu link or a PC5 link (or any suitable sidelink), in some cases. The vehicles may be connected for charging (e.g., connected to an EVSE at the vehicle user's home). Charge may be provided to or from the vehicle wirelessly in some aspects. A power line 750 (e.g., wired connection) may be coupled between the EVSE and the network-connected grid controller 708. The grid controller 708 may connect to the network using a Uu or PC5 link. The grid controller 708 may be coupled to control power transfer to or from the power grid 710.

Certain aspects of the present disclosure are directed towards techniques for grid-initiated V2G discharging. As used herein, V2G discharging generally refers to a transfer of charge from a vehicle to the grid (e.g., resulting in the vehicle being discharged). Grid-initiated signaling may be used to initialize and activate (also deactivate) V2G transfer. Some aspects are directed towards vehicle-initiated V2G discharging. Vehicle-initiated signaling may be used to identify, evaluate, and activate (or deactivate) V2G transfer. Some aspects are directed towards the selection of a vehicle group for discharging. Vehicle-to-vehicle (V2V) negotiation may be used before V2G discharge to identify which group vehicle may perform V2G discharging. For example, vehicles in a neighborhood (or fleet) may decide which set of vehicles are better-suited to perform V2G discharge and the percentage of total power that may be transferred by selected vehicles. Similarly, a group of vehicles in a single household may negotiate the power discharge or charging schedule. Certain decisions may be cost-efficient for the owner of these vehicles during power surges where prices are increased. Certain aspects of the present disclosure provide grid communication with SECC directly (e.g., as opposed to grid communication with the vehicle itself). For example, the grid may request energy from the SECC when the grid wants to initiate energy transfer. A V2G sleep cycle may be used in which a vehicle can drain the battery (e.g., during discharging) for some period and then charge a fractional amount based on a duty cycle. The cloud service operating with the grid may define the duty cycle.

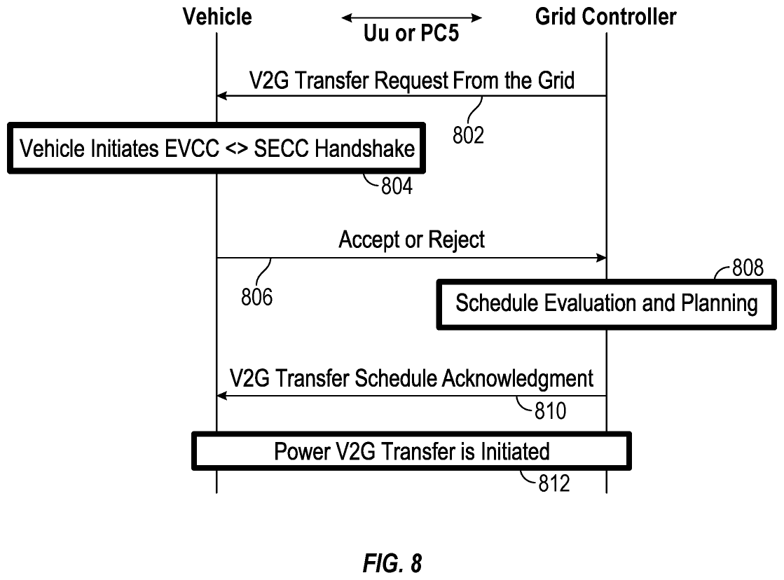

FIG. 8 illustrates example signaling to perform grid-initiated V2G discharging, in accordance with certain aspects of the present disclosure. As shown, at 802, the grid controller (e.g., grid controller 708 described with respect to FIG. 7, or network devices connected to the grid controller) may send a dedicated V2G transfer request message (e.g., on Uu link) to the connected vehicle (e.g., such as the vehicle 712 described with respect to FIG. 7). The request message may indicate various charge transfer characteristics. For example, the message may include one or more of the location of the grid controller, the total power requirements at the grid (e.g., during any time period in the day or night), and the cost benefit which may be provided by the grid controller. For example, if the vehicle completes the V2G transfer as requested, the vehicle owner may receive some discount on an electricity bill. The request may also include a schedule for the charge transfer to the grid. In some cases, the request may include universal time coordinated (UTC) timestamps associated with requests sent to the vehicle and/or a message count indicating the number of requests sent to the vehicle. The request may also include a security certificate, although inherited Uu or PC5 security may be reused in some cases.

At 804, the request may initiate a series of handshake messages between the EVCC and SECC via PLC to determine whether to perform the V2G transfer. At 806, a V2G transfer accept or reject message may be sent from the vehicle to the grid controller. The vehicle may send an accept message to the grid controlled (e.g., via 5G gNB or V2G cloud service). The accept message may indicate one or more of the V2G start and end schedule, vehicle ID, approximate location of the vehicle, and the total power that may be transferred throughout the transfer. In some aspects, the vehicle may follow the V2G transfer schedule computed by the grid controller (e.g., and indicated to the vehicle in the request message), in which case any schedule and power fields (e.g., indicating the amount of power transfer and schedule) may not be included in the accept message.

As described, the vehicle may send a reject message. The vehicle may obtain the consent of the owner to accept the transfer request. A vehicle may send a reject message indicating the cause of the rejection, if any imminent or emergency trip is planned or scheduled, if there is not enough battery, or the request is simply denied by the owner of the vehicle showing no interest in V2G participation.

If the start time for the power transfer is in the advanced future, the grid controller may initiate signaling of the transfer request as it gets closer to the scheduled time, depending upon power requirements at the grid. If the start time is in the short future, the grid controller may create a time schedule at block 808. For example, the grid controller may assign a periodic V2G transfer schedule for a vehicle during a certain period (e.g., and/or an aperiodic transfer schedule during another period). In one example, the grid controller may request the vehicle to only transfer a certain amount of power (e.g., a certain percentage of the total power transfer in kilowatt-hours (KWH)) for 20 minutes every 60 minutes). In another example, the vehicle may allocate a more extended one-time period or an aperiodic transfer schedule. In some cases, at block 808, the grid controller may accept (e.g., finalize) the schedule sent by the vehicle as part of the accept message. At 810, the grid controller sends an acknowledgment message before the charge transfer can be initiated. At block 812, V2G transfer may occur.

While some examples described herein include a grid controller sending an acknowledgement message, charge transfer may be initiated without an acknowledgment message in some cases. For example, the request message from the grid may also include a Boolean field referred to herein as a transfer without acknowledgment field. If the value of the field is set to true, the vehicle may not wait for the acknowledgment from the grid controller and V2G charge transfer may begin immediately after sending the accept message. If the value of the field is set to False, the vehicle will wait for the acknowledgment (if any) from the grid controller before initiating the V2G charge transfer.

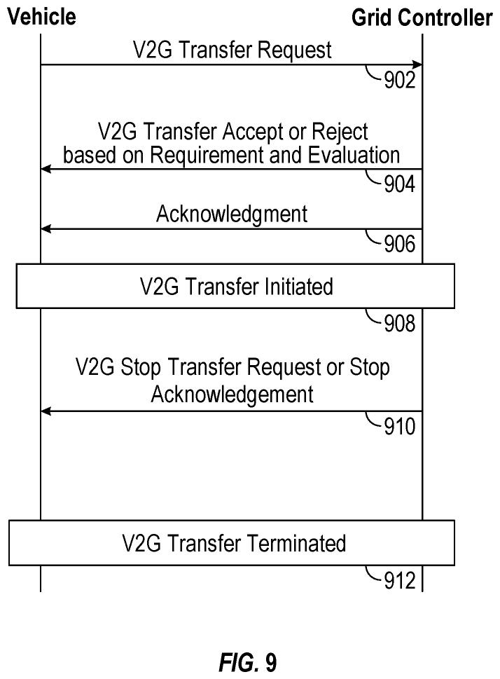

FIG. 9 illustrates an example of signaling to perform vehicle-initiated V2G discharging, in accordance with certain aspects of the present disclosure. At 902, the V2G transfer request originating from a vehicle (e.g., vehicle 712 of FIG. 7) to the grid controller (e.g., corresponding to the grid controller 708 of FIG. 7) may be sent. This message may include various V2G transfer parameters such as the current battery percentage of the vehicle, the V2G transfer window (e.g., including start and end time), the total power available for transfer, vehicle ID, and the owner's authorization for charge transfer. In some aspects, the vehicle-originated transfer request may be sent periodically over a certain duration or until a response is received from the grid. The request message may be sent when the vehicle is not stationary. For example, the vehicle may initiate the request en-route (e.g., while traveling to) to a particular destination.

At 904, a V2G transfer accept or reject message, originating from the grid controller to the vehicle, may be sent. The reject message may include a possible cause of the rejection. For example, a reject message may indicate that the grid doesn't require any V2G discharge or the grid controller is not functional. In some aspects, the reject message may indicate a different grid location that might be functional and need power. In some aspects, the accept or reject message may include a transfer without an acknowledgment field indicating whether the vehicle should wait for an acknowledgment message before initiating a charge transfer.

In some aspects, at 906, the grid controller sends an acknowledgment message before the charge transfer can be initiated. At block 908, V2G transfer may occur. In some cases, at 910, the grid controller may preemptively send a V2G transfer stop request if V2G discharge service is no longer required. If the V2G transfer duration has expired (e.g., sooner than scheduled per the transfer request/acceptance), the grid controller may send a stop acknowledgment. At block 912, the V2G transfer may be terminated, involving one or more handshake messages between the vehicle and the grid controller.

In some aspects, a vehicle may use history (e.g., driver commuting patterns or aggregated driver patterns in a household) to predict the time period over which a V2G discharge may be initiated for transfer scheduling. This process may be efficient and owner-agnostic. For example, a fully autonomous vehicle may automatically start and schedule the V2G transfer unless the owner changes the schedule.

As one example, a cloud-connected grid entity may receive V2G transfer requests from various vehicles (e.g., during a rush hour) and a priority associated with power transfer to the vehicle may be decided at the grid controller. The priority may be decided based on certain conditions, which may be implementation-specific. The grid controller may decide the priority before the acceptance or rejection message is sent.

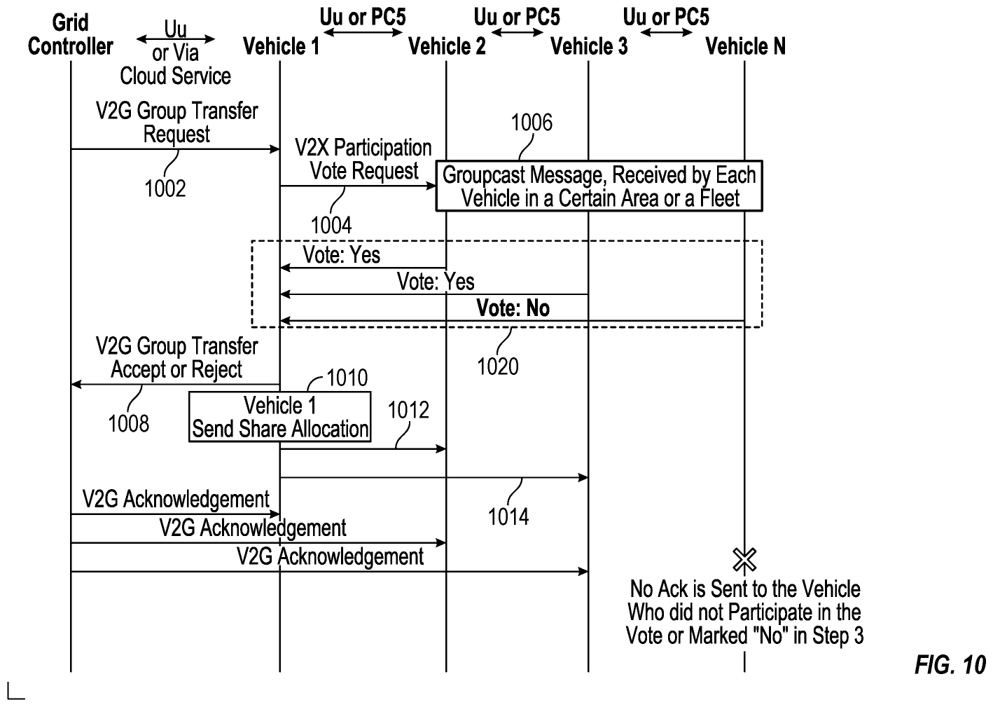

FIG. 10 illustrates an example of signaling for V2G selective group transfer, in accordance with certain aspects of the present disclosure. In some aspects, the signaling described with respect to FIG. 10 may occur after block 804 described with respect to FIG. 8. At 1002, a V2G group transfer request message may be sent by the grid controller (e.g., grid controller 708 of FIG. 7) to a vehicle (e.g., labeled “Vehicle 1”, such as vehicle 712 of FIG. 7). The request message may request power transfer from a group of vehicles (e.g., including “Vehicle 2” to “Vehicle N”, N being a positive integer, which may correspond to vehicles 714, 716 shown in FIG. 7). The request may include various parameters, such as the parameters included as part of the request message described with respect to FIG. 8 or FIG. 9. Additionally, the grid controller may advertise the total power requirement at the grid during a surge. The request may also indicate a group size. For example, the request may indicate whether the request is for charge transfer from vehicle in a particular neighborhood.

As shown, at 1004, a V2X group participation voting request message is broadcasted by vehicle 1. This voting request message may be sent using sidelink or the Uu link. At block 1006, the group message (voting request message) is received by Vehicle 2 to Vehicle N. As shown, at block 1020, each of the vehicles may respond with a participation message indicating a vote of either yes or no concerning participation in the V2G transfer.

In some aspects, vehicle 1 may receive or collect voting responses along with vehicle ID from vehicles that participated. For example, vehicles 2 and 3 may vote to participate in the V2G transfer, yet vehicle N may vote not to participate in the V2G transfer.

At 1008, vehicle 1 may send a group transfer accept message to the grid controller. The accept message may include a total number of vehicles in the group (e.g., 3 vehicles, including vehicles 1-3). If the total number of vehicles is less than two, then vehicle 1 may send a reject message at 1008.

At 1010, vehicle 1 computes a V2G discharge rate or power budget for each vehicle, then sends an allocation share message (e.g., messages 1012, 1014) to respective vehicles. For example, Vehicle 1 may request vehicle 2 and 3 to transfer 100 KWH and 200 KWH over 1 hour, respectively. Vehicle 1 may also account for its own share of power transfer. Vehicle 1 may act as a common controller for actions such as security, cost compensation computations, scheduling, or interrupt handling.

As shown, the grid controller may send a V2G acknowledgment message to each vehicle (Vehicle 1, Vehicle 2, and Vehicle 3) participating in the V2G transfer. As shown, an acknowledgment message may not be sent to Vehicle N that is not participating in the V2G transfer. In some aspects, if multiple vehicles (e.g., vehicle 1, vehicle 2, and vehicle 3) are owned by a single owner, the voting at block 1020 may be done at the vehicle owner's discretion.

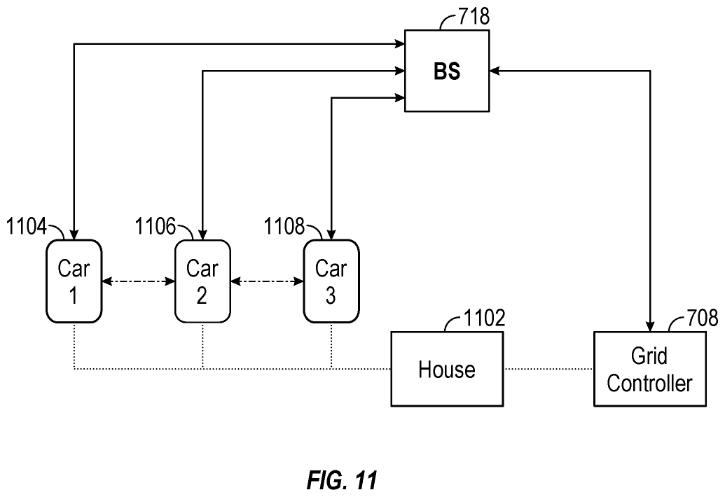

FIG. 11 illustrates a household with multiple vehicles (e.g., labeled Car 1, Car 2, and Car 3) for V2G transfer, in accordance with certain aspects of the present disclosure. As shown, each of the vehicles 1104, 1106, 1108 may be connected to the BS 718 (e.g., through respective Uu links). Each of the vehicles 1104, 1106, 1108 may include an EVCC and may be connected, via power lines, to an SECC for the house 1102. As shown, the vehicles 1104, 1106, 1108 may be communicably coupled via sidelink (e.g., PC5 interface). As described, the vehicles 1104, 1106, 1108 may perform the voting at block 1020 (e.g., in FIG. 10) at the discretion of the owner of the vehicles. In some cases, only one of the vehicles may send a voting message to the grid controller indicating whether one or more of the vehicles for the household will participate in the V2G transfer.

While some examples described herein have been described with respect to a grid controller communicating with one or more vehicles, certain aspects of the present disclosure may be performed with communication between the grid controller and the SECC. The SECC may be a private SECC (e.g., in house 1102) or a public SECC (e.g., an SECC at a charging station).

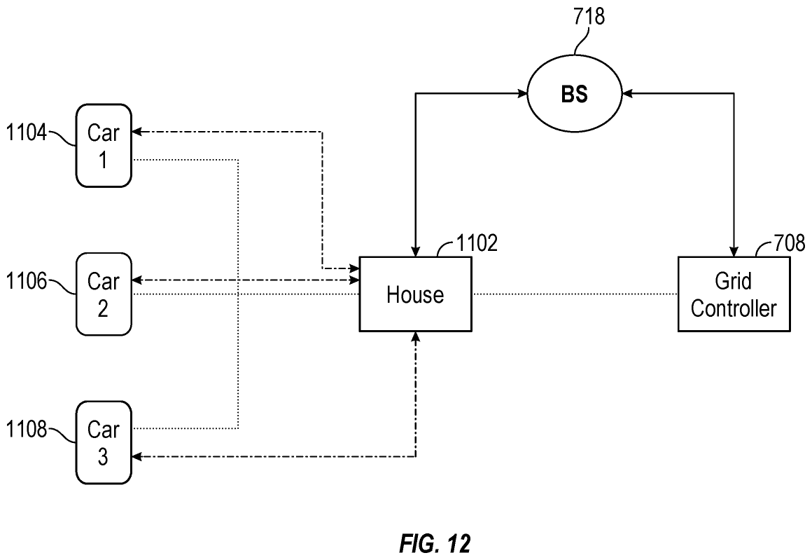

FIG. 12 illustrates example techniques for V2G transfer using communication between a grid controller 708 and an SECC (e.g., as part of house 1102), in accordance with certain aspects of the present disclosure. As shown, each of the vehicles may be coupled to an SECC (e.g., at house 1102) via a PC5 interface and to an EVSE (e.g., at house 1102) via power lines for charging and discharging. The EVSE may be coupled to the grid via a power line. The grid controller 708 may send a request message to the SECC requesting energy from the SECC when the grid determines to initiate energy transfer. The SECC may be responsible for managing (e.g., via PC5 or WiFi) charge levels between multiple vehicles (e.g., vehicles 1104, 1106, 1108), hence maintaining enough charge in each vehicle without completely discharging any vehicle. For example, if the vehicle initiates energy transfer, the vehicle may communicate with the concerned SECC (e.g., via wired or wireless communication), which may negotiate the energy transfer to the grid controller. The SECC may act as the “middle-man” that handles communication (e.g., via Uu or PC5 link) between the grid controller and vehicles. Private vehicle information such as location, and charge levels may not be transferred to the grid controller. Rather, SECC information may be sent to the grid controller. The grid controller may only ping the SECC if multiple vehicles are available to the SECC.

### Example Operations for Grid Initiated Charge Transfer

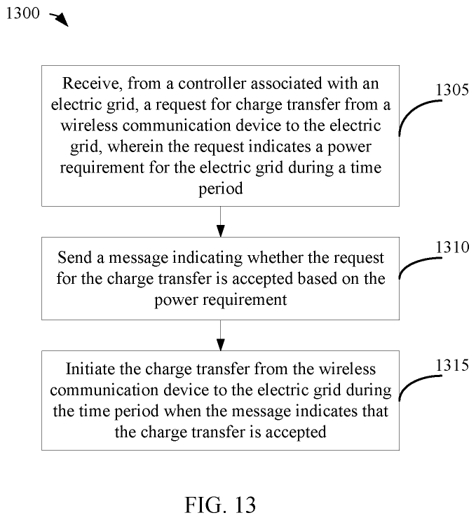

FIG. 13 shows an example of a method 1300 of device to grid charge transfer at a controller associated with a wireless communication device. The wireless communication device may be any equipment such as a heating, ventilation, and air conditioning (HVAC) system or a vehicle. The controller may be any network (e.g., 5G) enabled controller or any controller support signaling via a Uu and/or PC5 link. In some aspects, the controller may be a modem associated with the wireless communication device.

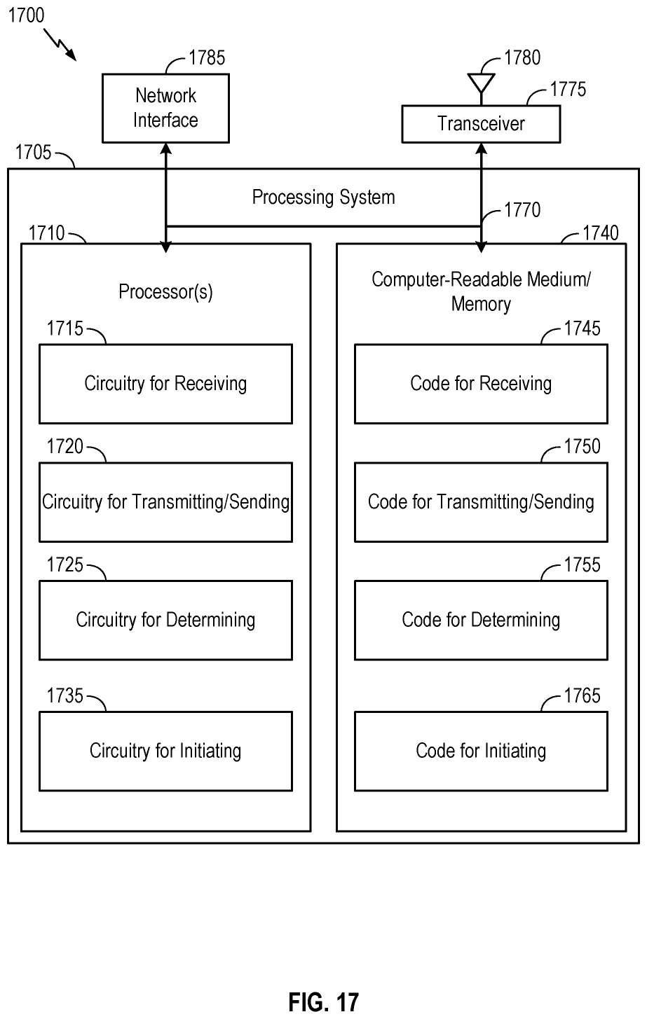

Method 1300 begins at step 1305 with the controller receiving, from a controller associated with an electric grid, a request for charge transfer from a wireless communication device to the electric grid. The request may indicate a power requirement for the electric grid during a time period. In some cases, the operations of this step refer to, or may be performed by, circuitry for receiving and/or code for receiving as described with reference to FIG. 17.

At step 1310, the controller sends a message indicating whether the request for the charge transfer is accepted based on the power requirement. In some cases, the operations of this step refer to, or may be performed by, circuitry for transmitting/sending and/or code for transmitting/sending as described with reference to FIG. 17.

At step 1315, the controller initiates the charge transfer from the wireless communication device to the electric grid during the time period when the message indicates that the charge transfer is accepted. In some cases, the operations of this step refer to, or may be performed by, circuitry for configuring and/or code for configuring as described with reference to FIG. 17. For example, initiating the charge transfer may involve providing charge from a battery of the wireless communication device to a DC link (e.g., DC link 502) coupled to the grid.

In some aspects, the request indicating the power requirement may include the request indicating an expected power surge during the time period. The request may further indicate charge transfer information including at least one of a location of the electric grid, a cost benefit to an owner of the wireless communication device for the charge transfer, a schedule associated with the charge transfer, one or more time stamps associated with the request, a message count indicating a number of requests sent to the wireless communication device, or a security certification, the message being sent based on the charge transfer information. In some aspects, the request may include an indication of whether to wait for reception of an acknowledgment message before performing the charge transfer.

In some aspects, the controller may receive an acknowledgment message in response to sending the message accepting the charge transfer. The charge transfer may be initiated based on receiving the acknowledgment message.

In some aspects, the controller may receive an indication of a periodic (or aperiodic) charge transfer schedule. In some cases, the controller may receive an indication of a periodic charge transfer schedule for charge transfer during a first time period and an indication of an aperiodic charge transfer schedule for charge transfer during a second time period.

In some aspects, the message accepts the charge transfer, the message including at least one of a charge transfer schedule, an identifier associated with the wireless communication device, a location of the wireless communication device, an authorization from an owner of the wireless communication device, or an amount of power to be transferred during the time period. In some cases, the message rejects the charge transfer, the message indicating a cause for the rejection of the charge transfer.

In some aspects, the wireless communication device is one of a plurality of wireless communication devices. The controller may send another request to one or more wireless communication devices of the plurality of wireless communication devices to participate in the charge transfer. The controller may receive a response from each of the one or more wireless communication devices indicating whether each of the one or more wireless communication devices will participate in the charge transfer in response to the other request. In this case, the message indicating whether the request for the charge transfer is accepted is sent based on the response from each of the one or more wireless communication devices. The controller may send, to each of the one or more wireless communication devices, an indication of an amount of power to be transferred by each of the one or more wireless communication devices. The message may indicate that the charge transfer is accepted, the message further indicating a first quantity of wireless communication devices that will participate in charge transfer to the electric grid based on the response from each of the one or more wireless communication devices. The request may indicate a second quantity of wireless communication devices requested to participate in charge transfer to the electric grid. The second quantity may be more than or equal to the first quantity of wireless communication devices.

In some aspects, the request may be received at a supply equipment communication controller (SECC) associated with the wireless communication device. The wireless communication device may be one of a plurality of wireless communication devices associated with the communication controller. Controlling the charge transfer may include controlling, via the SECC, charge transfer from each of the plurality of the wireless communication devices to the electric grid based on an amount remaining charge for each of the plurality of the wireless communication devices, a schedule set by an owner of a respective one of the wireless communication devices or by the electric grid for the respective one of the wireless communication devices, or an owner consent for the respective one of the wireless communication devices.

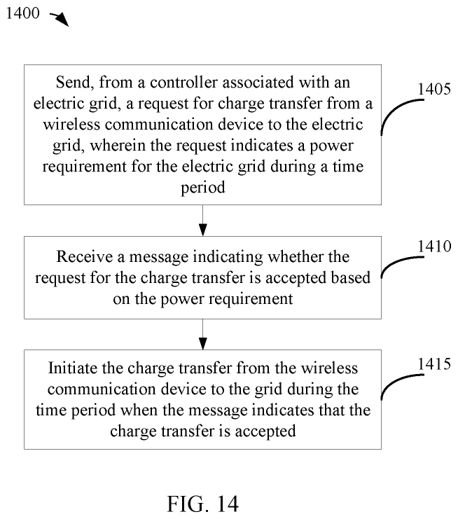

FIG. 14 shows an example of a method 1400 of device to grid charge transfer at a controller associated with a grid controller. The controller may be any network (e.g., 5G) enabled controller or any controller support signaling via a Uu and/or PC5 link.

Method 1400 begins at step 1405 with the controller sending a request for charge transfer from a wireless communication device to the electric grid. The request may indicate a power requirement for the electric grid during a time period. In some cases, the operations of this step refer to, or may be performed by, circuitry for sending and/or code for sending as described with reference to FIG. 17.

At step 1410, the controller receives a message indicating whether the request for the charge transfer is accepted based on the power requirement. In some cases, the operations of this step refer to, or may be performed by, circuitry for receiving and/or code for receiving as described with reference to FIG. 17.

At step 1415, the controller initiates the charge transfer from the wireless communication device to the grid during the time period when the message indicates that the charge transfer is accepted. In some cases, the operations of this step refer to, or may be performed by, circuitry for configuring and/or code for configuring as described with reference to FIG. 17. The wireless communication device may be a vehicle.

In some aspects, the request indicating the power requirement may include the request indicating an expected power surge during the time period. In some aspects, the request may also indicate charge transfer information including at least one of a location of the grid, a cost benefit to an owner of the wireless communication device for the charge transfer, a schedule associated with the charge transfer, one or more time stamps associated with the request, a message count indicating a number of requests sent to the wireless communication device, an authorization from an owner of the wireless communication device, or a security certification. The request may include an indication of whether to wait for reception of an acknowledgment message before performing the charge transfer.

In some aspects, the controller may send an acknowledgment message in response to receiving the message accepting the charge transfer, where the charge transfer is initiated based on sending the acknowledgment message. In some aspects, the controller may send an indication of a periodic charge transfer schedule, wherein the charge transfer is performed based on the periodic charge transfer schedule. The controller may send an indication of a periodic charge transfer schedule for charge transfer during a first time period and an indication of an aperiodic charge transfer schedule for charge transfer during a second time period.

In some aspects, the message accepts the charge transfer, the message including at least one of a charge transfer schedule, an identifier associated with the wireless communication device, a location of the wireless communication device, or an amount of power to be transferred during the time period. The message may reject the charge transfer, the message indicating a cause for the rejection of the charge transfer. The message may indicate that the charge transfer is accepted, the message further indicating a first quantity of wireless communication devices that will participate in charge transfer to the electric grid. The request may indicate a second quantity of wireless communication devices requested to participate in charge transfer to the electric grid, the second quantity being more than or equal to the first quantity of wireless communication devices.

The request may be sent to a supply equipment communication controller (SECC) associated with the wireless communication device, in some aspects. The wireless communication device may be one of a plurality of wireless communication devices associated with the SECC, the request being for charge transfer from the plurality of wireless communication devices.

### Example Operations for Device Initiated Charge Transfer

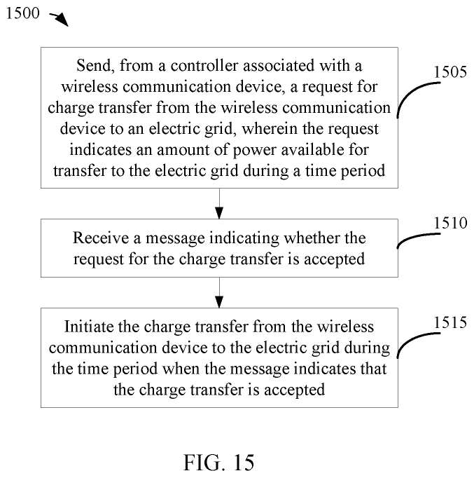

FIG. 15 shows an example of a method 1500 of device to grid charge transfer at a controller associated with a wireless communication device. The wireless communication device may be any equipment such as a heating, ventilation, and air conditioning (HVAC) system or a vehicle. The controller may be any network (e.g., 5G) enabled controller or any controller support signaling via a Uu and/or PC5 link. In some aspects, the controller may be a modem associated with the wireless communication device.

Method 1500 begins at step 1505 with the controller sending a request for charge transfer from the wireless communication device to an electric grid, wherein the request indicates an amount of power available for transfer to the electric grid during a time period. In some cases, the operations of this step refer to, or may be performed by, circuitry for sending and/or code for sending as described with reference to FIG. 17.

At step 1510, the controller receives a message indicating whether the request for the charge transfer is accepted. In some cases, the operations of this step refer to, or may be performed by, circuitry for receiving and/or code for receiving as described with reference to FIG. 17.

At step 1515, the controller initiates the charge transfer from the wireless communication device to the electric grid during the time period when the message indicates that the charge transfer is accepted. In some cases, the operations of this step refer to, or may be performed by, circuitry for configuring and/or code for configuring as described with reference to FIG. 17.

In some aspects, controller determines a schedule for the charge transfer based on history of operation of the wireless communication device. The request for the charge transfer may be sent based on the schedule. The request may further indicate charge transfer information including at least one of a current amount of available charge for the wireless communication device, a transfer window including start and end times for charge transfer, an identifier associated with the wireless communication device, or an authorization from an owner of the wireless communication device. In some aspects, the request is part of multiple requests for charge transfer sent periodically by the wireless communication device. The request may be send while the wireless communication device is non-stationary.

In some aspects, the controller receives an acknowledgment message after receiving the message accepting the charge transfer, wherein the charge transfer is initiated based on receiving the acknowledgment message. In some aspects, the message includes an indication of whether to wait for reception of an acknowledgment message before performing the charge transfer. In some aspects, the controller receives a stop transfer request, where the charge transfer is stopped based on the stop transfer request.

In some aspects, the message received by the controller associated with the wireless communication device rejects the charge transfer, the message indicating a cause for the rejection of the charge transfer. The message received by the controller associated with the wireless communication device may reject the charge transfer for a first grid location, the message indicating a second grid location for which charge transfer can be accepted.

In some aspects, the wireless communication device is one of a plurality of wireless communication devices. The controller may send another request to one or more wireless communication devices of the plurality of wireless communication devices to participate in the charge transfer and receive a response from each of the one or more wireless communication devices indicating whether each of the one or more wireless communication devices will participate in the charge transfer in response to the other request. Configuring the charge transfer may be based on the response from each of the one or more wireless communication devices. In some aspects, the controller sends, to each of the one or more wireless communication devices, an indication of an amount of power to be transferred by each of the one or more wireless communication devices. In some aspects, the request may further indicate a quantity of wireless communication devices that will participate in charge transfer to the electric grid based on the response for each of the one or more wireless communication devices.

The request may be sent by a supply equipment communication controller (SECC) associated with the wireless communication device. The wireless communication device may be one of a plurality of wireless communication devices associated with the SECC. Configuring the charge transfer may include configuring, via the SECC, charge transfer from each of the plurality of the wireless communication devices to the electric grid based on an amount of remaining charge for each of the plurality of wireless communication devices.

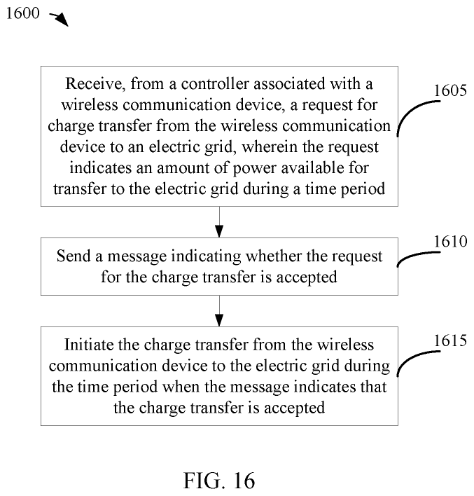

FIG. 16 shows an example of a method 1600 of device to grid charge transfer at a controller associated with a grid controller. The controller may be any network (e.g., 5G) enabled controller or any controller support signaling via a Uu and/or PC5 link.

Method 1600 begins at step 1605 with the controller receives, from a controller associated with a wireless communication device, a request for charge transfer from the wireless communication device to an electric grid. The request may indicate an amount of power available for transfer to the electric grid during a time period. In some cases, the operations of this step refer to, or may be performed by, circuitry for receiving and/or code for receiving as described with reference to FIG. 17.

At step 1610, the controller sends a message indicating whether the request for the charge transfer is accepted. In some cases, the operations of this step refer to, or may be performed by, circuitry for sending and/or code for sending as described with reference to FIG. 17.

At step 1615, the controller initiates the charge transfer from the wireless communication device to the electric grid during the time period when the message indicates that the charge transfer is accepted. In some cases, the operations of this step refer to, or may be performed by, circuitry for configuring and/or code for configuring as described with reference to FIG. 17. The wireless communication device may be a vehicle.

In some aspects, the request further indicates charge transfer information including at least one of a current amount of available charge for the wireless communication device, a transfer window including start and end times for charge transfer, an identifier associated with the wireless communication device, or an authorization from an owner of the wireless communication device, wherein the message is sent based on the charge transfer information. In some aspects the request is part of multiple requests for charge transfer received periodically from the wireless communication device.

The controller may send an acknowledgment message after sending the message accepting the charge transfer, wherein the charge transfer is initiated based on the acknowledgment message. The message may include an indication of whether to wait for reception of an acknowledgment message before performing the charge transfer. The controller may send a stop transfer request, wherein the charge transfer is stopped based on the stop transfer request.

In some aspects, the message rejects the charge transfer, the message indicating a cause for the rejection of the charge transfer. The message may reject the charge transfer for a first grid location, the message indicating a second grid location for which charge transfer can be accepted. In some aspects, the request further indicates a quantity of wireless communication devices that will participate in charge transfer to the electric grid.

In some aspects, the request may be received from a supply equipment communication controller (SECC) associated with the wireless communication device. The wireless communication device may be one of a plurality of wireless communication devices associated with the SECC, the request being for charge transfer from the plurality of wireless communication devices.

In some aspects, the request may be one of a plurality of requests received by a controller associated with the electric grid for charge transfer from a plurality of wireless communication devices. The controller may determine priorities associated with the plurality of requests, where the message is sent based on the determination.

### Example Communications Device(s)

FIG. 17 depicts aspects of an example communications device 1700. In some aspects, communications device 1700 is a controller (e.g., V2G controller, grid controller, modem, or any suitable network connected device).

The communications device 1700 includes a processing system 1705 coupled to the transceiver 1775 (e.g., a transmitter and/or a receiver). In some aspects (e.g., when communications device 1700 is a network entity), processing system 1705 may be coupled to a network interface 1785 that is configured to obtain and send signals for the communications device 1700 via communication link(s), such as a backhaul link, midhaul link, and/or fronthaul link as described herein, such as with respect to FIG. 2. The transceiver 1775 is configured to transmit and receive signals for the communications device 1700 via the antenna 1780, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1740 via a bus 1770. In certain aspects, the computer-readable medium/memory 1740 is configured to store instructions (e.g., computer-executable code) that when executed by the one or more processors 1710, cause the one or more processors 1710 to perform techniques described herein, or any aspect related to it. Note that reference to a processor performing a function of communications device 1700 may include one or more processors 1710 performing that function of communications device 1700.

In the depicted example, computer-readable medium/memory 1740 stores code (e.g., executable instructions), such as code for receiving 1745, code for transmitting/sending 1750, code for determining 1755, and code for initiating 1765. Processing of the code for receiving 1745, code for transmitting/sending 1750, code for determining 1755, and code for initiating 1765.

The one or more processors 1710 include circuitry configured to implement (e.g., execute) the code stored in the computer-readable medium/memory 1740, including circuitry for receiving 1715, circuitry for transmitting/sending 1720, circuitry for determining 1725, and circuitry for initiating 1735. Processing with circuitry for receiving 1715, circuitry for transmitting/sending 1720, circuitry for determining 1725, and circuitry for initiating 1735.

Various components of the communications device 1700 may provide means for performing the methods described herein or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1775 and the antenna 1780 of the communications device 1700 in FIG. 17. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1775 and the antenna 1780 of the communications device 1700 in FIG. 17.

### Example Clauses

Implementation examples are described in the following numbered clauses:

Aspect 1: A method for device to grid charge transfer, comprising: receiving, from a controller associated with an electric grid, a request for charge transfer from a wireless communication device to the electric grid, wherein the request indicates a power requirement for the electric grid during a time period; sending a message indicating whether the request for the charge transfer is accepted based on the power requirement; and initiating the charge transfer from the wireless communication device to the electric grid during the time period when the message indicates that the charge transfer is accepted.

Aspect 2: The method of Aspect 1, wherein the wireless communication device comprises a vehicle.

Aspect 3: The method of Aspect 1 or 2, wherein the request indicating the power requirement comprises the request indicating an expected power surge during the time period.

Aspect 4: The method according to any of Aspects 1-3, wherein the request further indicates charge transfer information including at least one of a location of the electric grid, a cost benefit to an owner of the wireless communication device for the charge transfer, a schedule associated with the charge transfer, one or more time stamps associated with the request, a message count indicating a number of requests sent to the wireless communication device, or a security certification, the message being sent based on the charge transfer information.

Aspect 5: The method according to any of Aspects 1-4, wherein the request comprises an indication of whether to wait for reception of an acknowledgment message before performing the charge transfer.

Aspect 6: The method according to any of Aspects 1-5, further comprising: receiving an acknowledgment message in response to sending the message accepting the charge transfer, wherein the charge transfer is initiated based on receiving the acknowledgment message.

Aspect 7: The method according to any of Aspects 1-6, further comprising receiving an indication of a periodic charge transfer schedule.

Aspect 8: The method according to any of Aspects 1-7, further comprising receiving an indication of a periodic charge transfer schedule for charge transfer during a first time period and an indication of an aperiodic charge transfer schedule for charge transfer during a second time period.

Aspect 9: The method according to any of Aspects 1-8, wherein the message accepts the charge transfer, the message including at least one of a charge transfer schedule, an identifier associated with the wireless communication device, a location of the wireless communication device, an authorization from an owner of the wireless communication device, or an amount of power to be transferred during the time period.

Aspect 10: The method according to any of Aspects 1-9, wherein the message rejects the charge transfer, the message indicating a cause for the rejection of the charge transfer.

Aspect 11: The method according to any of Aspects 1-10, wherein: the wireless communication device is one of a plurality of wireless communication devices; the method further comprises: sending another request to one or more wireless communication devices of the plurality of wireless communication devices to participate in the charge transfer; and receiving a response from each of the one or more wireless communication devices indicating whether each of the one or more wireless communication devices will participate in the charge transfer in response to the other request; and the message indicating whether the request for the charge transfer is accepted is sent based on the response from each of the one or more wireless communication devices.

Aspect 12: The method of Aspect 11, further comprising sending, to each of the one or more wireless communication devices, an indication of an amount of power to be transferred by each of the one or more wireless communication devices.

Aspect 13: The method of Aspect 11 or 12, wherein the message indicates that the charge transfer is accepted, the message further indicating a first quantity of wireless communication devices that will participate in charge transfer to the electric grid based on the response from each of the one or more wireless communication devices.

Aspect 14: The method of Aspect 13, wherein the request indicates a second quantity of wireless communication devices requested to participate in charge transfer to the electric grid, the second quantity being more than or equal to the first quantity of wireless communication devices.

Aspect 15: The method according to any of Aspects 1-14, wherein the request is received at a supply equipment communication controller (SECC) associated with the wireless communication device.

Aspect 16: The method of Aspect 15, wherein: the wireless communication device is one of a plurality of wireless communication devices associated with the communication controller; and configuring the charge transfer comprises configuring, via the SECC, charge transfer from each of the plurality of the wireless communication devices to the electric grid based on an amount remaining charge for each of the plurality of the wireless communication devices, a schedule set by an owner of a respective one of the wireless communication devices or by the electric grid for the respective one of the wireless communication devices, or an owner consent for the respective one of the wireless communication devices.

Aspect 17: A method for device to grid charge transfer, comprising: sending, from a controller associated with an electric grid, a request for charge transfer from a wireless communication device to the electric grid, wherein the request indicates a power requirement for the electric grid during a time period; receiving a message indicating whether the request for the charge transfer is accepted based on the power requirement; and initiating the charge transfer from the wireless communication device to the grid during the time period when the message indicates that the charge transfer is accepted.

Aspect 18: The method of Aspect 17, wherein the wireless communication device comprises a vehicle.

Aspect 19: The method of Aspect 17 or 18, wherein the request indicating the power requirement comprises the request indicating an expected power surge during the time period.

Aspect 20: The method according to any of Aspects 17-19, wherein the request further indicates charge transfer information including at least one of a location of the grid, a cost benefit to an owner of the wireless communication device for the charge transfer, a schedule associated with the charge transfer, one or more time stamps associated with the request, a message count indicating a number of requests sent to the wireless communication device, an authorization from an owner of the wireless communication device, or a security certification.

Aspect 21: The method according to any of Aspects 17-20, wherein the request comprises an indication of whether to wait for reception of an acknowledgment message before performing the charge transfer.

Aspect 22: The method according to any of Aspects 17-21, further comprising: sending an acknowledgment message in response to receiving the message accepting the charge transfer, wherein the charge transfer is initiated based on sending the acknowledgment message.

Aspect 23: The method according to any of Aspects 14-22, further comprising sending an indication of a periodic charge transfer schedule, wherein the charge transfer is performed based on the periodic charge transfer schedule.

Aspect 24: The method according to any of Aspects 17-23, further comprising sending an indication of a periodic charge transfer schedule for charge transfer during a first time period and an indication of an aperiodic charge transfer schedule for charge transfer during a second time period.

Aspect 25: The method according to any of Aspects 17-24, wherein the message accepts the charge transfer, the message including at least one of a charge transfer schedule, an identifier associated with the wireless communication device, a location of the wireless communication device, or an amount of power to be transferred during the time period.

Aspect 26: The method according to any of Aspects 17-25, wherein the message rejects the charge transfer, the message indicating a cause for the rejection of the charge transfer.

Aspect 27: The method according to any of Aspects 17-26, wherein the message indicates that the charge transfer is accepted, the message further indicating a first quantity of wireless communication devices that will participate in charge transfer to the electric grid.

Aspect 28: The method of Aspect 27, wherein the request indicates a second quantity of wireless communication devices requested to participate in charge transfer to the electric grid, the second quantity being more than or equal to the first quantity of wireless communication devices.

Aspect 29: The method according to any of Aspects 17-28, wherein the request is sent to a supply equipment communication controller (SECC) associated with the wireless communication device.

Aspect 30: The method of Aspect 29, wherein the wireless communication device is one of a plurality of wireless communication devices associated with the SECC, the request being for charge transfer from the plurality of wireless communication devices.

Aspect 31: A method for device to grid charge transfer, comprising: sending, from a controller associated with a wireless communication device, a request for charge transfer from the wireless communication device to an electric grid, wherein the request indicates an amount of power available for transfer to the electric grid during a time period; receiving a message indicating whether the request for the charge transfer is accepted; and initiating the charge transfer from the wireless communication device to the electric grid during the time period when the message indicates that the charge transfer is accepted.

Aspect 32: The method of Aspect 31, wherein the wireless communication device comprises a vehicle.

Aspect 33: The method of Aspect 31 or 32, further comprising determining a schedule for the charge transfer based on history of operation of the wireless communication device, wherein the request for the charge transfer is sent based on the schedule.

Aspect 34: The method according to any of Aspects 31-33, wherein the request further indicates charge transfer information including at least one of a current amount of available charge for the wireless communication device, a transfer window including start and end times for charge transfer, an identifier associated with the wireless communication device, or an authorization from an owner of the wireless communication device.

Aspect 35: The method according to any of Aspects 31-34, wherein the request is part of multiple requests for charge transfer sent periodically by the wireless communication device.

Aspect 36: The method according to any of Aspects 31-35, wherein the request is send while the wireless communication device is non-stationary.

Aspect 37: The method according to any of Aspects 31-36, further comprising: receiving an acknowledgment message after receiving the message accepting the charge transfer, wherein the charge transfer is initiated based on receiving the acknowledgment message.

Aspect 38: The method according to any of Aspects 31-37, wherein the message comprises an indication of whether to wait for reception of an acknowledgment message before performing the charge transfer.

Aspect 39: The method according to any of Aspects 31-38, further comprising receiving a stop transfer request, wherein the charge transfer is stopped based on the stop transfer request.

Aspect 40: The method according to any of Aspects 31-39, wherein the message received by the controller associated with the wireless communication device rejects the charge transfer, the message indicating a cause for the rejection of the charge transfer.

Aspect 41: The method of Aspect 40, wherein the message received by the controller associated with the wireless communication device rejects the charge transfer for a first grid location, the message indicating a second grid location for which charge transfer can be accepted.

Aspect 42: The method according to any of Aspects 31-41, wherein: the wireless communication device is one of a plurality of wireless communication devices; the method further comprising: sending another request to one or more wireless communication devices of the plurality of wireless communication devices to participate in the charge transfer; and receiving a response from each of the one or more wireless communication devices indicating whether each of the one or more wireless communication devices will participate in the charge transfer in response to the other request; and initiating the charge transfer is based on the response from each of the one or more wireless communication devices.

Aspect 43: The method of Aspect 42, further comprising sending, to each of the one or more wireless communication devices, an indication of an amount of power to be transferred by each of the one or more wireless communication devices.

Aspect 44: The method of Aspect 42 or 43, wherein the request further indicates a quantity of wireless communication devices that will participate in charge transfer to the electric grid based on the response for each of the one or more wireless communication devices.

Aspect 45: The method according to any of Aspects 31-44, wherein the request is sent by a supply equipment communication controller (SECC) associated with the wireless communication device.

Aspect 46: The method of Aspect 45, wherein: the wireless communication device is one of a plurality of wireless communication devices associated with the SECC; and configuring the charge transfer comprises configuring, via the SECC, charge transfer from each of the plurality of the wireless communication devices to the electric grid based on an amount of remaining charge for each of the plurality of wireless communication devices.

Aspect 47: A method for device to grid charge transfer, comprising: receiving, from a controller associated with a wireless communication device, a request for charge transfer from the wireless communication device to an electric grid, wherein the request indicates an amount of power available for transfer to the electric grid during a time period; sending a message indicating whether the request for the charge transfer is accepted; and initiating the charge transfer from the wireless communication device to the electric grid during the time period when the message indicates that the charge transfer is accepted.

Aspect 48: The method of Aspect 47, wherein the wireless communication device comprises a vehicle.

Aspect 49: The method of Aspect 47 or 48, wherein the request further indicates charge transfer information including at least one of a current amount of available charge for the wireless communication device, a transfer window including start and end times for charge transfer, an identifier associated with the wireless communication device, or an authorization from an owner of the wireless communication device, wherein the message is sent based on the charge transfer information.

Aspect 50: The method according to any of Aspects 47-49, wherein the request is part of multiple requests for charge transfer received periodically from the wireless communication device.

Aspect 51: The method according to any of Aspects 47-50, further comprising: sending an acknowledgment message after sending the message accepting the charge transfer, wherein the charge transfer is initiated based on the acknowledgment message.

Aspect 52: The method according to any of Aspects 47-51, wherein the message comprises an indication of whether to wait for reception of an acknowledgment message before performing the charge transfer.

Aspect 53: The method according to any of Aspects 47-52, further comprising sending a stop transfer request, wherein the charge transfer is stopped based on the stop transfer request.

Aspect 54: The method according to any of Aspects 47-53, wherein the message rejects the charge transfer, the message indicating a cause for the rejection of the charge transfer.

Aspect 55: The method of Aspect 54, wherein the message rejects the charge transfer for a first grid location, the message indicating a second grid location for which charge transfer can be accepted.

Aspect 56: The method according to any of Aspects 47-55, wherein the request further indicates a quantity of wireless communication devices that will participate in charge transfer to the electric grid.

Aspect 57: The method according to any of Aspects 47-56, wherein the request is received from a supply equipment communication controller (SECC) associated with the wireless communication device.

Aspect 58: The method of Aspect 57, wherein the wireless communication device is one of a plurality of wireless communication devices associated with the SECC, the request being for charge transfer from the plurality of wireless communication devices.

Aspect 59: The method according to any of Aspects 47-58, wherein the request is one of a plurality of requests received by a controller associated with the electric grid for charge transfer from a plurality of wireless communication devices, the method further comprising determining priorities associated with the plurality of requests, wherein the message is sent based on the determination.

Aspect 60: An apparatus, comprising: a memory comprising executable instructions; and at least one processor configured to execute the executable instructions and cause the apparatus to perform a method in accordance with any one of Aspects 1-59.

Aspect 61: An apparatus, comprising means for performing a method in accordance with any one of Aspects 1-59.

Aspect 62: A non-transitory computer-readable medium comprising executable instructions that, when executed by at least one processor of an apparatus, cause the apparatus to perform a method in accordance with any one of Aspects 1-59.

Aspect 63: A computer program product embodied on a computer-readable storage medium comprising code for performing a method in accordance with any one of Aspects 1-59.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, or multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for device to grid charge transfer, comprising:
at least one processor;
at least one memory coupled with the at least one processor; and
instructions stored in the memory and executable by the at least one processor to cause the apparatus to:
receive, from a controller associated with an electric grid, a request for charge transfer from a wireless communication device to the electric grid, wherein the request indicates a power requirement for the electric grid during a time period;
send a message indicating whether the request for the charge transfer is accepted based on the power requirement; and
initiate the charge transfer from the wireless communication device to the electric grid during the time period when the message indicates that the charge transfer is accepted.

2. The apparatus of claim 1, wherein the request further indicates charge transfer information including at least one of a location of the electric grid, a cost benefit to an owner of the wireless communication device for the charge transfer, a schedule associated with the charge transfer, one or more time stamps associated with the request, a message count indicating a number of requests sent to the wireless communication device, or a security certification, the message being sent based on the charge transfer information.

3. The apparatus of claim 1, wherein the instructions further cause the apparatus to receive an acknowledgment message in response to sending the message accepting the charge transfer, wherein the charge transfer is initiated based on receiving the acknowledgment message.

4. The apparatus of claim 1, wherein the message accepts the charge transfer, the message including at least one of a charge transfer schedule, an identifier associated with the wireless communication device, a location of the wireless communication device, an authorization from an owner of the wireless communication device, or an amount of power to be transferred during the time period.

5. The apparatus of claim 1, wherein:
the wireless communication device is one of a plurality of wireless communication devices;
the instructions further cause the apparatus to:
send another request to one or more wireless communication devices of the plurality of wireless communication devices to participate in the charge transfer; and
receive a response from each of the one or more wireless communication devices indicating whether each of the one or more wireless communication devices will participate in the charge transfer in response to the other request; and
the message indicating whether the request for the charge transfer is accepted is sent based on the response from each of the one or more wireless communication devices.

6. The apparatus of claim 5, wherein the instructions further cause the apparatus to send, to each of the one or more wireless communication devices, an indication of an amount of power to be transferred by each of the one or more wireless communication devices.

7. The apparatus of claim 5, wherein the message indicates that the charge transfer is accepted, the message further indicating a first quantity of wireless communication devices that will participate in charge transfer to the electric grid based on the response from each of the one or more wireless communication devices.

8. The apparatus of claim 1, wherein the request is received at a supply equipment communication controller (SECC) associated with the wireless communication device.

9. The apparatus of claim 8, wherein:
the wireless communication device is one of a plurality of wireless communication devices associated with the SECC; and
to configuring the charge transfer, the instructions cause the apparatus to configure, via the SECC, charge transfer from each of the plurality of the wireless communication devices to the electric grid based on an amount remaining charge for each of the plurality of the wireless communication devices, a schedule set by an owner of a respective one of the plurality of wireless communication devices or by the electric grid for the respective one of the plurality of wireless communication devices, or an owner consent for the respective one of the plurality of wireless communication devices.

10. A apparatus for device to grid charge transfer, comprising:
at least one processor;
at least one memory coupled with the at least one processor; and
instructions stored in the memory and executable by the at least one processor to cause the apparatus to:
send, from a controller associated with an electric grid, a request for charge transfer from a wireless communication device to the electric grid, wherein the request indicates a power requirement for the electric grid during a time period;
receive a message indicating whether the request for the charge transfer is accepted based on the power requirement; and
initiate the charge transfer from the wireless communication device to the grid during the time period when the message indicates that the charge transfer is accepted.

11. The apparatus of claim 10, wherein the request further indicates charge transfer information including at least one of a location of the grid, a cost benefit to an owner of the wireless communication device for the charge transfer, a schedule associated with the charge transfer, one or more time stamps associated with the request, a message count indicating a number of requests sent to the wireless communication device, an authorization from an owner of the wireless communication device, or a security certification.

12. The apparatus of claim 10, wherein the instructions further cause the apparatus to send an acknowledgment message in response to receiving the message accepting the charge transfer, wherein the charge transfer is initiated based on sending the acknowledgment message.

13. The apparatus of claim 10, wherein the request is sent to a supply equipment communication controller (SECC) associated with the wireless communication device.

14. The apparatus of claim 13, wherein the wireless communication device is one of a plurality of wireless communication devices associated with the SECC, the request being for charge transfer from the plurality of wireless communication devices.

15. A apparatus for device to grid charge transfer, comprising:
at least one processor;
at least one memory coupled with the at least one processor; and
instructions stored in the memory and executable by the at least one processor to cause the apparatus to:
send, from a controller associated with a wireless communication device, a request for charge transfer from the wireless communication device to an electric grid, wherein the request indicates an amount of power available for transfer to the electric grid during a time period;
receive a message indicating whether the request for the charge transfer is accepted; and
initiate the charge transfer from the wireless communication device to the electric grid during the time period when the message indicates that the charge transfer is accepted.

16. The apparatus of claim 15, wherein the instructions further cause the apparatus to determine a schedule for the charge transfer based on history of operation of the wireless communication device, wherein the request for the charge transfer is sent based on the schedule.

17. The apparatus of claim 15, wherein the request further indicates charge transfer information including at least one of a current amount of available charge for the wireless communication device, a transfer window including start and end times for charge transfer, an identifier associated with the wireless communication device, or an authorization from an owner of the wireless communication device.

18. The apparatus of claim 15, wherein the instructions further cause the apparatus to:
receive an acknowledgment message after receiving the message accepting the charge transfer, wherein the charge transfer is initiated based on receiving the acknowledgment message.

19. The apparatus of claim 15, wherein the message received by the controller associated with the wireless communication device rejects the charge transfer, the message indicating a cause for the rejection of the charge transfer.

20. The apparatus of claim 19, wherein the message received by the controller associated with the wireless communication device rejects the charge transfer for a first grid location, the message indicating a second grid location for which charge transfer can be accepted.

21. The apparatus of claim 15, wherein:
the wireless communication device is one of a plurality of wireless communication devices;
the instructions further cause the apparatus to:
send another request to one or more wireless communication devices of the plurality of wireless communication devices to participate in the charge transfer; and
receive a response from each of the one or more wireless communication devices indicating whether each of the one or more wireless communication devices will participate in the charge transfer in response to the other request; and
the instructions cause the apparatus to configure the charge transfer based on the response from each of the one or more wireless communication devices.

22. The apparatus of claim 21, wherein the instructions further cause the apparatus to send, to each of the one or more wireless communication devices, an indication of an amount of power to be transferred by each of the one or more wireless communication devices.

23. The apparatus of claim 15, wherein the request is sent by a supply equipment communication controller (SECC) associated with the wireless communication device.

24. The apparatus of claim 23, wherein:
the wireless communication device is one of a plurality of wireless communication devices associated with the SECC; and
to configuring the charge transfer, the instructions cause the apparatus to configure, via the SECC, charge transfer from each of the plurality of the wireless communication devices to the electric grid based on an amount of remaining charge for each of the plurality of wireless communication devices.

25. A apparatus for device to grid charge transfer, comprising:
at least one processor;
at least one memory coupled with the at least one processor; and
instructions stored in the memory and executable by the at least one processor to cause the apparatus to:
receive, from a controller associated with a wireless communication device, a request for charge transfer from the wireless communication device to an electric grid, wherein the request indicates an amount of power available for transfer to the electric grid during a time period;
send a message indicating whether the request for the charge transfer is accepted; and
initiate the charge transfer from the wireless communication device to the electric grid during the time period when the message indicates that the charge transfer is accepted.

26. The apparatus of claim 25, wherein the request further indicates charge transfer information including at least one of a current amount of available charge for the wireless communication device, a transfer window including start and end times for charge transfer, an identifier associated with the wireless communication device, or an authorization from an owner of the wireless communication device, wherein the message is sent based on the charge transfer information.

27. The apparatus of claim 25, wherein the request is received from a supply equipment communication controller (SECC) associated with the wireless communication device.

28. The apparatus of claim 27, wherein the wireless communication device is one of a plurality of wireless communication devices associated with the SECC, the request being for charge transfer from the plurality of wireless communication devices.

29. The apparatus of claim 25, wherein the request is one of a plurality of requests received by a controller associated with the electric grid for charge transfer from a plurality of wireless communication devices, the instructions further causing the at least one processor to determine priorities associated with the plurality of requests, wherein the message is sent based on the determination.
